(19) United States
(12) Patent Application Publication
(10) Pub. No.: US 2021/0006559 A1
(43) Pub. Date: Jan. 7, 2021

(54) SYSTEM AND METHOD FOR IDENTIFYING PAIRS OF RELATED INFORMATION ITEMS

(71) Applicant: Verint Systems Ltd., Herzliya Pituach (IL)

(72) Inventors: Yitshak Yishay, Revava (IL); Omer Ziv, Rehovot (IL); Itsik Horovitz, Holon (IL); Shlomo Rothschild, Nitzan (IL)

(21) Appl. No.: 16/916,433

(22) Filed: Jun. 30, 2020

(30) Foreign Application Priority Data
Jul. 2, 2019 (IL) 267783

(51) Int. Cl. H04L 29/06

(52) U.S. Cl. CPC H04L 63/0876; H04L 2463/082; H04L 63/0236

(57) ABSTRACT

A system for identifying related pairs of information items. In a context, monitoring devices acquire various information items by monitoring people over time. Such information items may include imaged features of the people, alphanumeric identifiers such as IMSIs, and/or the certain types of events. The system identifies, based on the monitored information, indications of relatedness, each of which indicates that a respective pair of the information items may be related to one another with respect to certain predefined criteria. For example, the processor may identify instances of copresence, in each of which a pair of information items were exhibited at approximately the same time and at approximately the same location. In response to identifying a sufficient number of indications of relatedness for any particular pair, the processor may hypothesize that the pair are related to one another.

### FIELD OF THE DISCLOSURE

The present disclosure relates to computational techniques for processing large amounts of data.

### BACKGROUND OF THE DISCLOSURE

In some cases, processing large amounts of data may require allocating significant resources, such as memory resources, central processing unit (CPU) resources, and time.

### SUMMARY OF THE DISCLOSURE

There is provided, in accordance with some embodiments of the present invention, an apparatus including a data-transfer interface and a processor. The processor is configured to receive data via the data-transfer interface. The processor is further configured to identify, based on the received data, (i) indications of relatedness, which indicate that respective pairs of information items are each related to one another, and (ii) indications of unrelatedness, each of which indicates that a respective pair of the pairs are unrelated to one another. The processor is further configured to maintain, responsively to identifying the indications of relatedness and the indications of unrelatedness, a repository in which a dynamic subset of the pairs are stored in association with respective relatedness scores, by continually modifying membership of the subset and the relatedness scores. The processor is further configured to receive a query specifying a first one of the information items, to identify, in response to the query, at least one second one of the information items that is paired with the first one of the information items in the repository, and to output the second one of the information items in response to identifying the second one of the information items.

In some embodiments, the processor is configured to continually modify the membership of the subset by, in response to identifying any one of the indications of relatedness for a first one of the pairs that is not in the repository, and in response to a number of the pairs in the repository being equal to a predefined threshold, replacing a second one of the pairs, with which is associated, in the repository, a lowest one of the relatedness scores, with the first one of the pairs.

In some embodiments, the processor is configured to, in replacing the second one of the pairs with the first one of the pairs, set the relatedness score associated with the first one of the pairs higher than a second-lowest one of the relatedness scores.

In some embodiments, the processor is configured to continually modify the membership of the subset by, in response to identifying each indication of unrelatedness of at least some of the indications of unrelatedness, removing, from the repository, the pair for which the indication of unrelatedness was identified.

In some embodiments, the processor is further configured to add the removed pair to a blacklist, and the processor is configured to replace the second one of the pairs with the first one of the pairs in response to the first one of the pairs not being in the blacklist.

In some embodiments, the processor is further configured to:

identify respective times at which, per the data, the indications of unrelatedness were exhibited, and

based on the identified times, remove, from the blacklist, any one of the pairs for which no indication of unrelatedness was exhibited for at least a predefined amount of time.

In some embodiments, the processor is configured to continually modify the relatedness scores by, in response to identifying any one of the indications of relatedness for any one of the pairs that is in the repository, increasing the relatedness score associated with the pair.

In some embodiments, the information items include a plurality of device-identifiers that identify respective devices.

In some embodiments, each of the pairs includes two of the device-identifiers.

In some embodiments, each of the device-identifiers is of a type selected from the group of types consisting of: an International Mobile Subscriber Identity (IMSI), an International Mobile Equipment Identity (IMEI), and a media access control (MAC) address.

In some embodiments,

the data include a plurality of images,

the information items further include a plurality of features shown in the images, and

each of the pairs includes a respective one of the device-identifiers and a respective one of the features.

In some embodiments, the features include respective faces.

In some embodiments, the information items further include respective event-types, and each of the pairs includes a respective one of the device-identifiers and a respective one of the event-types.

In some embodiments, the processor is configured to identify the indications of relatedness by:

identifying respective times at which, per the data, the information items were exhibited, and

based on the identified times, identifying instances of coincidence, in each of which the respective times at which a respective one of the pairs were exhibited are separated by less than a predefined interval.

In some embodiments,

the predefined interval is a first predefined interval, and

the processor is configured to identify the indications of unrelatedness by, based on the identified times, identifying instances of non-coincidence, in each of which the respective times at which a respective one of the pairs were exhibited are separated by more than a second predefined interval.

In some embodiments, the processor is configured to identify the indications of relatedness by:

identifying respective times and locations at which, per the data, the information items were exhibited, and

based on the identified times and locations, identifying instances of copresence, in each of which a respective one of the pairs were exhibited at respective ones of the times that are separated by less than a predefined interval, at respective ones of the locations that are separated by less than a predefined distance.

In some embodiments,

the predefined interval is a first predefined interval and the predefined distance is a first predefined distance, and

the processor is configured to identify the indications of unrelatedness by, based on the identified times and locations, identifying instances of bilocation, in each of which a respective one of the pairs were exhibited at respective ones of the times that are separated by less than a second predefined interval but at respective ones of the locations that are separated by more than a second predefined distance.

In some embodiments, the processor is configured to identify the indications of relatedness on a first execution thread, and to identify the indications of unrelatedness on a second execution thread executed in parallel to the first execution thread.

There is further provided, in accordance with some embodiments of the present invention, a method including receiving data and, based on the received data, identifying (i) indications of relatedness, which indicate that respective pairs of information items are each related to one another, and (ii) indications of unrelatedness, each of which indicates that a respective pair of the pairs are unrelated to one another. The method further includes, responsively to identifying the indications of relatedness and the indications of unrelatedness, maintaining a repository in which a dynamic subset of the pairs are stored in association with respective relatedness scores, by continually modifying membership of the subset and the relatedness scores. The method further includes receiving a query specifying a first one of the information items, in response to the query, identifying at least one second one of the information items that is paired with the first one of the information items in the repository, and in response to identifying the second one of the information items, outputting the second one of the information items.

There is further provided, in accordance with some embodiments of the present invention, a computer software product including a tangible non-transitory computer-readable medium in which program instructions are stored. The instructions, when read by a processor, cause the processor to receive data. The instructions further cause the processor to identify, based on the received data, (i) indications of relatedness, which indicate that respective pairs of information items are each related to one another, and (ii) indications of unrelatedness, each of which indicates that a respective pair of the pairs are unrelated to one another. The instructions further cause the processor to maintain, responsively to identifying the indications of relatedness and the indications of unrelatedness, a repository in which a dynamic subset of the pairs are stored in association with respective relatedness scores, by continually modifying membership of the subset and the relatedness scores. The instructions further cause the processor to receive a query specifying a first one of the information items, to identify, in response to the query, at least one second one of the information items that is paired with the first one of the information items in the repository, and to output the second one of the information items in response to identifying the second one of the information items.

The present disclosure will be more fully understood from the following detailed description of embodiments thereof, taken together with the drawings, in which:

### BRIEF DESCRIPTION OF THE DRAWINGS

FIG. 1 is a schematic illustration of a system for identifying pairs of related information items, in accordance with some embodiments of the present disclosure;

FIG. 2 is a schematic illustration of a technique for identifying pairs of related information items, in accordance with some embodiments of the present disclosure;

FIG. 3 is a flow diagram for an algorithm for maintaining a repository of pairs of information items, in accordance with some embodiments of the present disclosure; and

FIGS. 4-5 are flow diagrams for algorithms for maintaining a blacklist of pairs of information items, in accordance with some embodiments of the present disclosure.

### DETAILED DESCRIPTION OF EMBODIMENTS

### Overview

Embodiments of the present disclosure provide a system for identifying related pairs of information items by efficiently processing large amounts of data. For example, the system described herein may identify (i.e., hypothesize with a relatively high level of confidence) that a particular pair of International Mobile Subscriber Identities (IMSIs) belong to the same user (i.e., belong to one or more devices used by the same user), or that a particular IMSI belongs to the user whose face is shown in a particular image. Such information may be helpful for advertising agencies, law enforcement agencies, or other interested parties.

More specifically, the system described herein comprises one or more monitoring devices configured to acquire various information items by monitoring a large number of people over time. Such information items may include, for example, imaged features of the people, alphanumeric identifiers such as IMSIs, and/or the certain types of events. The system further comprises a processor, configured to receive, from the monitoring devices, data that include the information items. The processor is further configured to identify, based on the data, indications of relatedness, each of which indicates that a respective pair of the information items may be related to one another with respect to certain predefined criteria. For example, the processor may identify instances of copresence, in each of which a pair of information items were exhibited at approximately the same time and at approximately the same location. In response to identifying a sufficient number of indications of relatedness for any particular pair, the processor may hypothesize that the pair are related to one another.

Hypothetically, the processor could store, in a repository, each pair of information items for which at least one indication of relatedness was observed. The processor could further store, in association with the pair, a relatedness score that is based on the number of indications of relatedness that were identified for the pair. After a period of time, the processor could hypothesize that any pair having a relatively high relatedness score are related to one another, with a level of confidence that is an increasing function of the relatedness score.

However, this technique would require a prohibitively large amount of memory resources, CPU resources, and processing time. Moreover, relying solely on the identified indications of relatedness might cause a large number of false positives to be returned. For example, the processor might hypothesize that two IMSIs belonging to different respective individuals actually belong to the same individual, if the individuals work or live at the same location and are therefore frequently copresent with one another.

Hence, embodiments of the present disclosure use a superior technique, which does not overly tax the resources of the system, and which reduces the number of false positives that are returned. Per this technique, each new potentially-related pair of information items is added to the aforementioned repository only if the pair is not listed in a false-positive blacklist, which is constructed as described below. Thus, the number of false positives returned by the system is reduced. Moreover, the number of pairs in the repository is not allowed to exceed a predefined maximum number. If, prior to adding a new pair, the repository is already full, the processor discards the pair in the repository having the lowest relatedness score. Thus, the number of potentially-related pairs that are stored by the processor does not become prohibitively large.

To construct the false-positive blacklist, the processor repeatedly iterates through the pairs in the repository, or at least through a subset of the pairs having the highest relatedness scores. For each of these pairs, the processor checks whether the data include any indications of unrelatedness for the pair. For example, the processor may check whether the data include an instance of bilocation, in which the pair were exhibited at sufficiently different locations at approximately the same time. In response to identifying an indication of unrelatedness, the processor may remove the pair from the repository and add the pair to the blacklist.

Advantageously, to identify the indications of unrelatedness, the processor may operate a crawler that runs in parallel to the main thread of execution, which is used for identifying indications of relatedness. Thus, identifying the indications of unrelatedness does not slow the main thread of execution.

### System Description

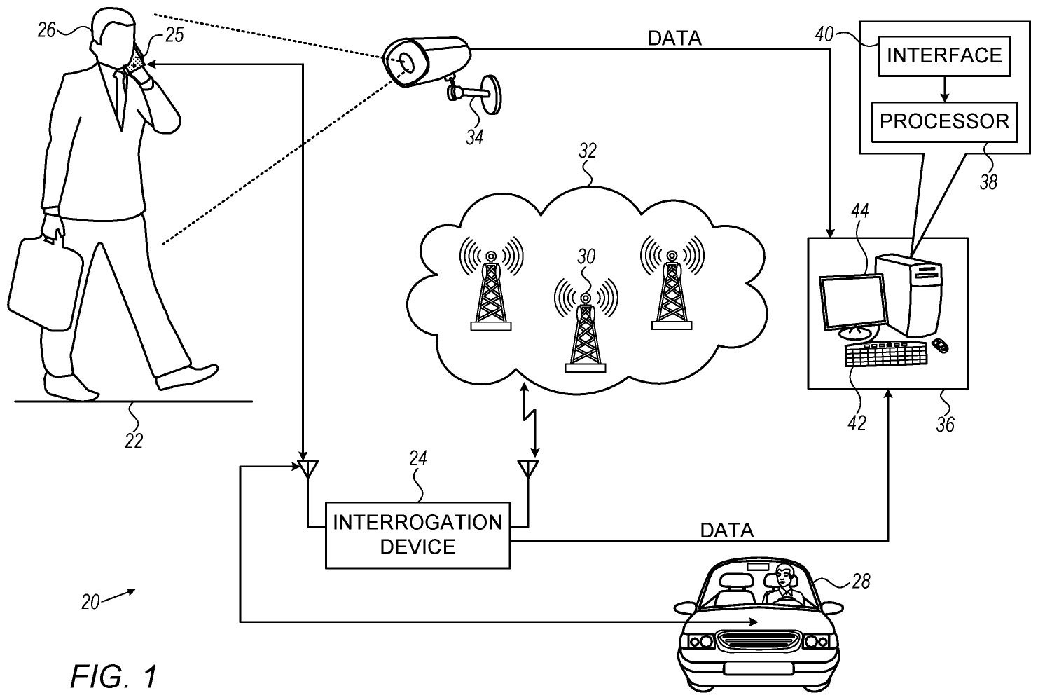

Reference is initially made to FIG. 1, which is a schematic illustration of a system 20 for identifying pairs of related information items, in accordance with some embodiments of the present disclosure.

System 20 comprises one or more monitoring devices configured to monitor various areas 22 through which individuals 26 pass on foot, in motorized vehicles 28, or in any other way. System 20 further comprises a server 36, comprising a processor 38 and a data-transfer interface 40. Via data-transfer interface 40, processor 38 receives data from the monitoring devices belonging to system 20, and/or from a third party. For example, the processor may receive a live or archived network traffic feed from a router or switch belonging to a network, or from an Internet Service Provider (ISP). The data received by processor 38 include various information items related to individuals 26. Some types of information items may be specified explicitly in the data. Other types may be included only implicitly; hence, the processor may be configured to process the data so as to derive the information items therefrom.

For example, system 20 may comprise at least one interrogation device 24, which is configured to solicit cellular communication devices 25 belonging to individuals 26 by imitating the operation of a legitimate base station 30 belonging to a cellular network 32. Subsequently to soliciting a cellular communication device 25, interrogation device 24 may intermediate a communication session between the cellular device and network 32, and thus obtain a device-identifier, such as an IMSI or an International Mobile Equipment Identity (IMEI), of the cellular device. The data received from interrogation device 24 may thus specify a plurality of device-identifiers that identify cellular communication devices 25. (It is noted that multiple device-identifiers may identify the same device, as in the case of a device using multiple subscriber identity module (SIM) cards.)

Subsequently to identifying each device-identifier in the data from interrogation device 24, the processor may associate the device-identifier with the time and/or location at which, per the data, the device-identifier was exhibited. For example, the processor may associate the device-identifier with the time at which the device-identifier was acquired by the interrogation device, or any other time at which the cellular communication device was in communication with the interrogation device. Alternatively or additionally, the processor may associate the device-identifier with the entire area of coverage of the interrogation device, or with an annular area between x and y meters from the interrogation device in which the device is estimated to have been located. X and y may be computed by the interrogation device or by the processor based on the strength of the signals received from the cellular communication device, taking into account any factors that may cause the signal strength to vary non-monotonically with distance from the interrogation device.

Alternatively or additionally, system 20 may comprise one or more imaging devices 34 (e.g., video cameras belonging to a video surveillance system), which acquire images of individuals 26 and/or of vehicles 28. Using suitable image processing techniques, the processor may identify, in the images, identifying features of individuals 26 or of vehicles 28, such as faces or license plates. Each such feature may be associated with the time and/or location at which, per the data, the feature was exhibited. For example, each feature may be associated with the time at which the feature was imaged, and/or the location of the imaging device 34 that imaged the feature.

In some embodiments, the processor uses video tracking techniques to ascertain the trajectory of an entity identified in a video. Based on the ascertained trajectory, the processor may extrapolate backwards or forwards in time, so as to derive additional times and locations for the imaged features. For example, the processor may estimate, based on the trajectory of a person imaged at location X at time t₀, that the person was at location Y at time t₁. Consequently, the processor may associate a feature of the person with location Y and time t₁.

Alternatively or additionally, system 20 may comprise at least one network tap, configured to monitor communication over a network such as a cellular network, a local area network (LAN) (e.g., a WiFi network), or the Internet, and to send a record of this communication to processor 38. By analyzing this record, the processor may identify information items such as a user ID used for an application, or a media access control (MAC) address belonging to a phone, a computer (such as a laptop or tablet), a peripheral device for a computer (such as a keyboard or mouse), a smart watch, earphones, or any other device. (Examples of MAC addresses include WiFi, Bluetooth, and near-field communication (NFC) addresses.) Each such information item may be associated with the time at which the information item was communicated over the network, and/or (if possible) the location at which the entity associated with the information item was located at that time.

Alternatively or additionally, based on the data from the network tap, the processor may identify the occurrence of certain types of events, such as a transaction at a store or bank. Each unique type of event may be associated with each time and/or location at which an event of the type occurred.

In general, the data may be specified in any suitable format. In some embodiments, data-transfer interface 40 comprises a network interface controller (NIC) or another network interface; in such embodiments, processor 38 may receive at least some of the data over a network, such as the Internet. Alternatively or additionally, data-transfer interface 40 may comprise a Universal Serial Bus (USB) port, an optical disc drive, or another interface configured to read at least some of the data from a USB flash drive, an optical disc, or another computer-readable medium.

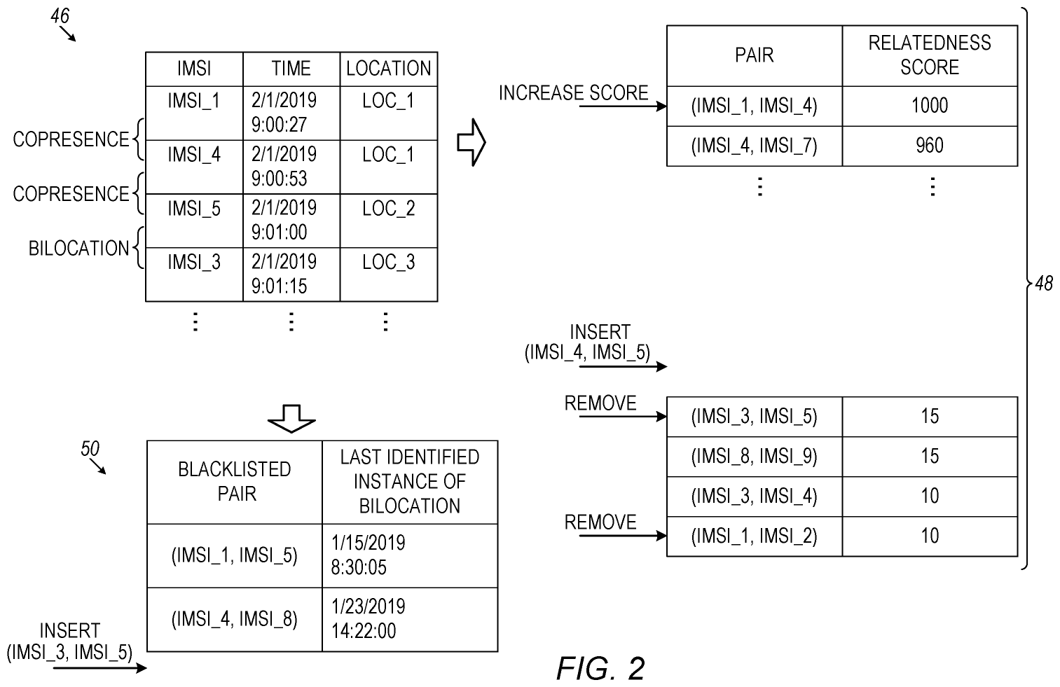

Server 36 may further comprise any suitable peripheral devices, which may be used, for example, for interfacing with a user. For example, the server may comprise a keyboard 42, which may be used by a user to query processor 38 for one or more information items, as further described below with reference to FIG. 2. The server may further comprise a monitor 44, on which the processor may display the results of any query.

In general, processor 38 may be embodied as a single processor, or as a cooperatively networked or clustered set of processors. In some embodiments, the functionality of processor 38, as described herein, is implemented solely in hardware, e.g., using one or more Application-Specific Integrated Circuits (ASICs) or Field-Programmable Gate Arrays (FPGAs). In other embodiments, the functionality of processor 38 is implemented at least partly in software. For example, in some embodiments, processor 38 is embodied as a programmed digital computing device comprising at least a central processing unit (CPU) and random access memory (RAM). Program code, including software programs, and/or data are loaded into the RAM for execution and processing by the CPU. The program code and/or data may be downloaded to the processor in electronic form, over a network, for example. Alternatively or additionally, the program code and/or data may be provided and/or stored on non-transitory tangible media, such as magnetic, optical, or electronic memory. Such program code and/or data, when provided to the processor, produce a machine or special-purpose computer, configured to perform the tasks described herein.

### Identifying Pairs of Related Information Items

Reference is now made to FIG. 2, which is a schematic illustration of a technique for identifying pairs of related information items, in accordance with some embodiments of the present disclosure. (Although FIG. 2 illustrates an application involving pairs of device-identifiers, the technique illustrated in FIG. 2 may also be used for applications involving other types of pairs of information items, as described in detail below.)

As described above with reference to FIG. 1, processor 38 receives data from the monitoring devices belonging to system 20, and/or from external sources. As described in detail below, by processing the data, the processor identifies (i) indications of relatedness, which indicate that respective pairs of information items are each related to one another, and (ii) indications of unrelatedness, each of which indicates that a respective pair of information items are unrelated to one another. These indications are used to identify pairs of related information items.

In general, the definition of “relatedness” varies from application to application. For example, two device-identifiers may be considered related to one another by virtue of belonging to the same user. As another example, two user IDs for a communication application may be considered related to one another by virtue of belonging to respective users who communicated with one another using the application. As yet another example, a device-identifier and an imaged feature of a person may be considered related to one another by virtue of the device-identifier belonging to the person. As yet another example, a device-identifier belonging to a person, or an imaged feature of the person, may be considered related to a particular event-type, by virtue of the person having participated in events of the event-type.

In some cases, the processor identifies the indications of relatedness from the raw data that are received. Typically, however, the processor first preprocesses the data by identifying the information items, removing extraneous information, and/or adding the time and/or location at which each information item was exhibited, if such information is not specified explicitly in the data. The processor may thus generate preprocessed data 46 that include a plurality of data points, each data point including a respective information item along with the time and/or location at which the information item was exhibited. (The same information item may be included in multiple data points.) The processor then identifies the indications of relatedness from preprocessed data 46.

For example, as shown in FIG. 2, each data point in preprocessed data 46 may include an IMSI acquired by interrogation device 24, along with the time and location at which the IMSI was exhibited. As described above with reference to FIG. 1, the time associated with the IMSI may be any time at which the device possessing the IMSI was in communication with the interrogation device, such as the time at which the IMSI was acquired. Alternatively, the data point may include both the first and last times at which the device was in communication with the interrogation device.

It is noted that the location of each data point may be specified to any particular degree of precision. For example, in some cases, the location may be specified as a point; for example, each imaged feature acquired by an imaging device may be assigned the latitude and longitude at which the imaging device is located. In other cases, as for acquired IMSIs, the location may be specified as an area, as described above with reference to FIG. 1.

Typically, each indication of relatedness requires that the pair of information items were exhibited at approximately the same time, i.e., within a predefined interval Δt₁ of one another. Optionally, the indication of relatedness may additionally require that the pair were exhibited at approximately the same location, i.e., at respective locations that are within a predefined distance Δd₁ of one another. An instance in which two information items were exhibited at approximately the time and location is referred to herein as an “instance of copresence.” An instance in which two information items were exhibited at approximately the time but not necessarily at the same approximate location is referred to herein as an “instance of coincidence.”

For example, an instance of copresence for (i) a pair of device-identifiers, (ii) a device-identifier and an imaged feature, (iii) a device-identifier and an event-type, or (iv) an imaged feature and an event-type, may be deemed to constitute an indication of relatedness. As another example, for a pair of user IDs, an instance of coincidence, in which the user IDs were used for communication at approximately the same time, may be deemed to constitute an indication of relatedness.

It is noted that in the context of the present application, including the claims, two information items are said to have been exhibited at respective locations that are within a predefined distance of one another if either (i) the two information items share the same location, or (ii) the two information items have different respective locations that are separated by less than the predefined distance. In the event that at least one of the locations is specified as an area, the processor may use any suitable method to compute the distance between the locations. For example, to compute the distance between a point P and an area A, the processor may compute the distance between P and any other point in A, such as the point in A that is farthest from or closest to P.

For applications in which each indication of relatedness includes an instance of coincidence, each indication of unrelatedness typically includes an instance of non-coincidence, in which the pair were exhibited at respective times separated from one another by more than another predefined interval Δt₂, which is typically greater than Δt₁.

For applications in which each indication of relatedness includes an instance of copresence, each indication of unrelatedness typically includes an instance of bilocation, in which the pair were exhibited within another predefined interval Δt₂ of one another at respective locations that are separated by more than another predefined distance Δd₂. Typically, Δd₂ is greater than Δd₁, and/or Δt₂ is less than Δt₁. In the event that at least one of the locations is specified as an area, the processor may use any suitable method to compute the distance between the locations, as described above.

Thus, for example, based on the hypothetical data in FIG. 2, the processor may identify two instances of copresence, assuming that the locations LOC_1 and LOC_2 are within Δd₁ of one another and that Δt₁ is at least 26 seconds. In one of these instances, IMSI_1 was copresent with IMSI_4; in the other instance, IMSI_4 was copresent with IMSI_5. The processor may further identify an instance of bilocation for the pair (IMSI_3, IMSI_5), assuming that the locations LOC_2 and LOC_3 are not within Δd₂ of one another.

Responsively to identifying the indications of relatedness and the indications of unrelatedness, the processor maintains a repository 48 in which a dynamic subset of the pairs to which the indications of relatedness pertain are stored in association with respective relatedness scores. In particular, in response to the indications, the processor continually modifies membership of the subset and the relatedness scores. (The subset stored in repository 48 is said to be “dynamic” by virtue of the processor continually modifying membership of the subset, i.e., replacing some of the pairs stored in the repository with other pairs.) Repository 48 may be embodied by any suitable data structure, such as a fixed-length array of structures or objects.

Each relatedness score is an increasing function of the number of indications of relatedness that were identified for the pair with which the score is associated. Thus, for example, in the hypothetical scenario shown in FIG. 2, the pair (IMSI_1, IMSI_4) may have the highest relatedness score by virtue of the number of instances of copresence that were identified for (IMSI_1, IMSI_4) being greater than for any other pair of IMSIs.

In some embodiments, the relatedness score is also a function of the respective strengths of the indications, i.e., the degree to which relatedness is indicated by each of the indications. In particular, a stronger indication may be cause for a greater increase in score, relative to a weaker indication. A stronger indication of relatedness may include, for example, an instance of copresence in which the two information items are associated with the same location, and the location is specified to a relatively high degree of precision.

More specifically, the processor may continually modify the population of pairs in the repository and the relatedness scores by performing one or more (typically, all) of the following functions:

(i) In response to identifying each indication of relatedness for any pair of information items that is already in the repository, the processor may increase the relatedness score associated with the pair. For example, in the scenario shown in FIG. 2, in response to identifying an instance of copresence for (IMSI_1, IMSI_4), the processor may increase the relatedness score of (IMSI_1, IMSI_4).

(ii) In response to identifying each indication of relatedness for any pair of information items that is not in the repository, and in response to the number of pairs in the repository being equal to a predefined threshold, the processor may replace another pair, which is associated with the lowest relatedness score in the repository, with the pair. Given that the repository is typically embodied by a data structure having a fixed size (e.g., a fixed-length array), the aforementioned threshold is typically equivalent to the size of the repository; in other words, if the repository is full, the processor replaces the lowest-score pair in the repository with the newly-identified pair.

For example, in the scenario shown in FIG. 2, assuming that the repository is full, the processor may remove (IMSI_1, IMSI_2), which has the lowest relatedness score in the repository, from the repository, and insert (IMSI_4, IMSI_5) into the repository. (Notwithstanding the above, in some cases, despite the indication of relatedness pertaining to a pair that is not in the repository, the processor may refrain from inserting the pair into the repository, as further described below.)

Typically, the processor sets the relatedness score associated with the newly-added pair higher than the second-lowest relatedness score, i.e., higher than the lowest relatedness score remaining in the repository after the removal of the replaced pair. For example, FIG. 2 shows (IMSI_4, IMSI_5) inserted into the repository somewhere above the remaining lowest-score pair in the repository. This helps prevent the newly-added pair from being immediately removed from the repository upon the addition of the next new pair to the repository. In some embodiments, the processor computes the relatedness score for the newly-added pair by adding a predefined constant to the score of the removed pair.

(iii) In response to identifying each of at least some of the indications of unrelatedness, the processor may remove, from the repository, the pair of information items for which the indication of unrelatedness was identified. For example, for each identified indication of unrelatedness, the processor may remove the pair to which the indication pertains. Alternatively, the processor may not remove the pair on the basis of a single identified indication of unrelatedness; rather, the pair may be removed only if the total number of identified indications of unrelatedness for the pair within a preceding time period (e.g., a predefined number of preceding weeks or months) exceeds a predefined threshold N, which may be two, three, or more. In such embodiments, the processor may maintain, for each pair in repository 48, a list of the times at which any indications of unrelatedness were exhibited for the pair. The lists may be stored, for example, in the repository itself.

For example, in the scenario in FIG. 2, (IMSI_3, IMSI_5) may be removed from the repository, in response to identifying an instance of bilocation for this pair.

Given that the removal of a pair from the repository creates a vacancy in the repository, the processor may insert the next newly-identified pair into the repository without first removing another pair. For example, with reference to FIG. 2, if (IMSI_3, IMSI_5) is removed from the repository before (IMSI_4, IMSI_5) is identified, the latter pair may be inserted without first removing (IMSI_1, IMSI_2).

Typically, to help prevent double-counting, the processor requires that each instance of coincidence be sufficiently separated in time from the most recent instance of coincidence for the pair. Similarly, the processor typically requires that each instance of copresence be sufficiently separated, in time or in space, from the most recent instance of copresence for the pair. For example, the processor may require that, for each instance of copresence, (i) the time of the instance is at least four hours from the time of the most recent instance of copresence for the pair, or (ii) the location of the instance is at least 20 km from the location of the most recent instance. If an identified instance of coincidence or copresence does not satisfy this criterion, no changes to the repository are made.

In some embodiments, the time tᵢ of each indication of relatedness—i.e., the time at which the indication is deemed to have been exhibited per the data—is defined as the later of the respective times at which the copresent pair were exhibited. In other embodiments, tᵢ is defined as the average, or as any other suitable function of, the respective times of the copresent pair. Likewise, the location of each instance of copresence may be defined as any suitable function of, such as the average of, the respective locations of the copresent pair. For example, if the respective locations for the copresent pair are expressed as latitude-and-longitude pairs (LAT1, LON1) and (LAT2, LON2), the location of the instance of copresence may be computed as ((LAT1+LAT2)/2, (LON1+LON2)/2).

Typically, the processor executes at least two execution threads in parallel to one another. On the first execution thread, the processor identifies indications of relatedness, as described above. On the second execution thread, the processor performs repeated iterations through the repository, or at least through the pairs of information items in the repository having the highest scores. (For example, the processor may iterate through the top 10%-50% of pairs in the repository.) During each of the iterations, the processor identifies any new indications of unrelatedness, and (optionally) removes one or more pairs from the repository responsively thereto, as described above.

Typically, the processor (e.g., on the aforementioned second execution thread) also adds, to a blacklist 50, each pair that is removed from the repository responsively to an indication of unrelatedness. For example, in the scenario shown in FIG. 2, (IMSI_3, IMSI_5) may be added to blacklist 50. Blacklist 50 may be embodied by a hash table, or by any other suitable data structure.

In such embodiments, the processor adds a pair of information items to repository 48 (e.g., by replacing the lowest-score pair that is already in the repository) in response to the pair not being in the blacklist. In other words, upon identifying each indication of relatedness for a pair that is not already in the repository, the processor checks whether the pair to which the indication pertains is contained in blacklist 50. If yes, the processor ignores the pair; otherwise, the processor adds the pair to the repository. (It is noted that the processor may check whether the pair is in the repository before or after checking if the pair is in the blacklist.)

Typically, blacklist 50 includes, for each blacklisted pair, the time of the last identified indication of unrelatedness (e.g., instance of bilocation) for the pair. In such embodiments, the processor may remove, from the blacklist, any one of the pairs for which no indication of unrelatedness was identified for at least a predefined amount of time (e.g., 1-3 months). This removal may be performed, for example, on a third execution thread that iterates through the blacklist. As described above for indications of relatedness, the time of any given indication of unrelatedness may be defined as the later of, or as any other suitable function of, the respective times associated with the pair of information items.

Subsequently to or while still processing the data, the processor may receive a query specifying one of the information items. In response to the query, the processor may identify at least one other information item that is paired, in the repository, with the information item specified in the query. Typically, the processor identifies the other information item only if the relatedness score of the pair is in a predefined highest percentile of the relatedness scores; for example, the processor may require that the relatedness score be in the highest 20^{th}, 10^{th}, or 5^{th} percentile. In response to identifying the other information item, the processor outputs the other information item.

For example, with reference to FIG. 2, the processor may receive a query specifying IMSI_4. In response thereto, given the hypothetical state of repository 48 shown in FIG. 2, the processor may identify both IMSI_1 and IMSI_7, each of which is paired with IMSI_4 with a relatively high score. In response to identifying IMSI_1 and IMSI_7, the processor may output both IMSI_1 and IMSI_7, indicating that IMSI_1 and/or IMSI_7 may belong to the same user as does IMSI_4.

If no other information item is paired with the specified information item with a sufficiently high relatedness score, the processor does not return any results. Instead, the processor may generate an appropriate output indicating that no suitable results were found.

### Example Algorithms

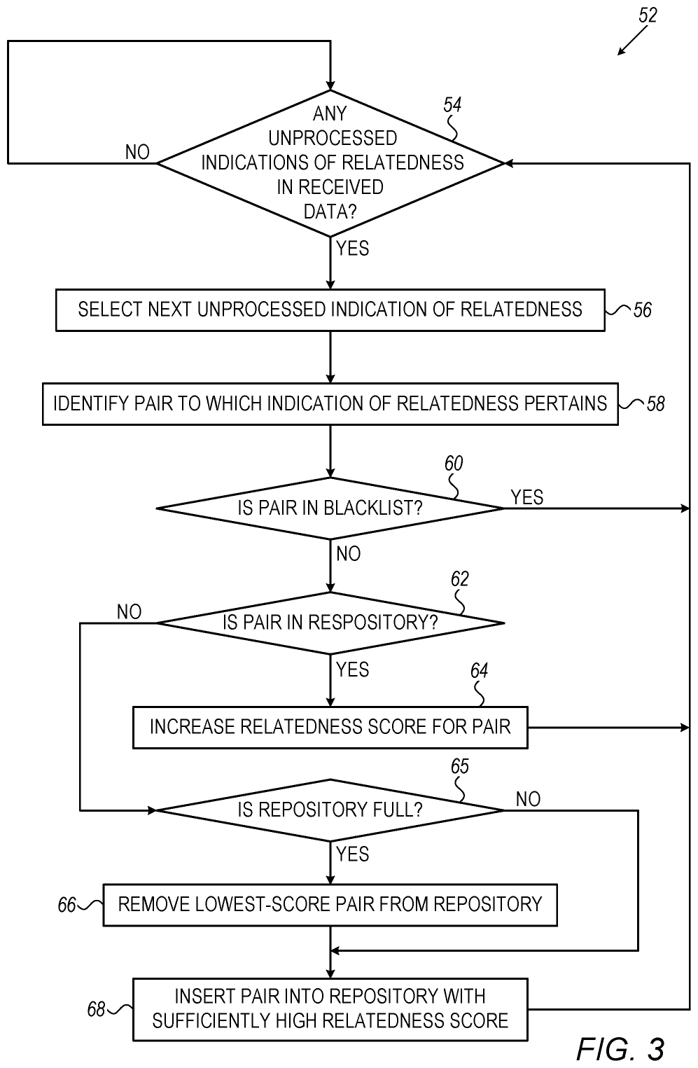

Reference is now made to FIG. 3, which is a flow diagram for an algorithm 52 for maintaining repository 48 (FIG. 2), which is executed by processor 38 (FIG. 1) in accordance with some embodiments of the present disclosure.

Per algorithm 52, processor 38 repeatedly checks, at a checking step 54, whether the data that have been received (and, optionally, preprocessed) thus far include any indications of relatedness that have not yet been processed. If yes, the processor, at an indication-selecting step 56, selects the next unprocessed indication of relatedness. Subsequently, at a pair-identifying step 58, the processor identifies the pair of information items to which the selected indication of relatedness pertains. Alternatively, if the data do not include any unprocessed indications of relatedness, the processor (e.g., after a suitable timeout) returns to checking step 54.

Following pair-identifying step 58, the processor, at a blacklist-consulting step 60, ascertains whether the selected pair is listed in blacklist 50 (FIG. 2). If yes, the processor does not process the indication of relatedness any further, and returns to checking step 54. Otherwise, the processor, at a repository-consulting step 62, ascertains whether the selected pair is included in the repository. If yes, the processor increases the relatedness score for the selected pair at a score-increasing step 64, and then returns to checking step 54. (As described above with reference to FIG. 2, repository-consulting step 62 may alternatively be performed prior to blacklist-consulting step 60.)

On the other hand, if the selected pair is not yet in the repository, the processor, at a repository-status-checking step 65, checks whether the repository is full. If the repository is not full—for example, if one or more pairs were recently moved from the repository to the blacklist, or if the repository was only recently initialized—the processor, at an inserting step 68, inserts the selected pair into the repository. Otherwise, the processor, at a removing step 66, removes the lowest-score pair from the repository, and then performs inserting step 68. Typically, as described above with reference to FIG. 2, the selected pair is inserted into the repository with a relatedness score that is sufficiently high so as to exceed the lowest relatedness score in the repository.

Following inserting step 68, the processor returns to checking step 54.

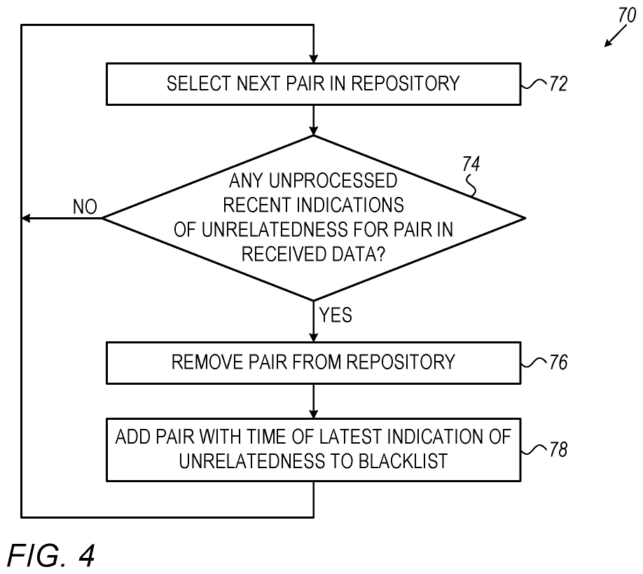

Reference is now made to FIG. 4, which is a flow diagram for an algorithm 70 for maintaining blacklist 50 (FIG. 2), in accordance with some embodiments of the present disclosure. Algorithm 70 is executed by processor 38 (FIG. 1), typically in parallel to algorithm 52 (FIG. 3).

Per algorithm 70, the processor repeatedly iterates through the pairs of information items in repository 48 (FIG. 2), or at least through a subset of the pairs having the highest relatedness scores. During each iteration, the processor selects each pair of information items at a pair-selecting step 72. Subsequently to pair-selecting step 72, the processor, at a data-consulting step 74, ascertains whether the data include any unprocessed recent indications of unrelatedness for the selected pair. In other words, given the current time t₁, the processor checks whether the data contain any unprocessed indications of unrelatedness for the pair exhibited after the time t₁−λ for a predefined interval λ, such as a predefined number of weeks or months.

If an unprocessed recent indication of unrelatedness is identified, the processor, at a first pair-removing step 76, removes the selected pair from the repository. Subsequently, the processor adds the selected pair, along with the time of the latest indication of unrelatedness identified for the pair, to the blacklist, at a blacklist-updating step 78. (Blacklist-updating step 78 may alternatively be performed before first pair-removing step 76.) Subsequently, or if no unprocessed recent indications of unrelatedness are identified for the selected pair, the processor returns to pair-selecting step 72.

Alternatively, as described above with reference to FIG. 2, following data-consulting step 74, the processor may append the time of each newly-identified indication of unrelatedness to a list of times associated with the pair. The processor may then check whether the number of recent indications is greater than a threshold N≥2. If yes, the processor may proceed to first pair-removing step 76; otherwise, the processor may return to pair-selecting step 72.

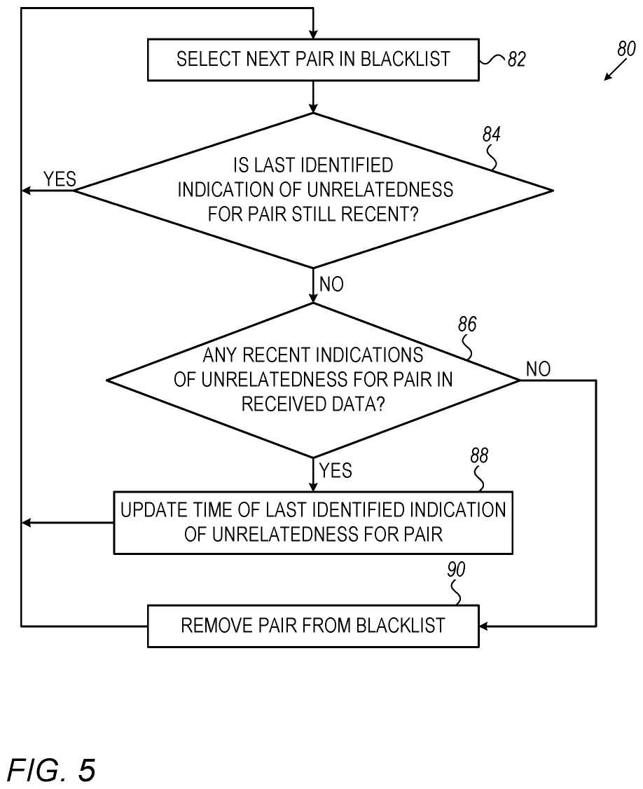

Reference is now made to FIG. 5, which is a flow diagram for another algorithm 80 for maintaining blacklist 50 (FIG. 2), in accordance with some embodiments of the present disclosure. Algorithm 80 is executed by processor 38 (FIG. 1), typically in parallel to algorithm 52 (FIG. 3) and algorithm 70 (FIG. 4).

Per algorithm 80, the processor repeatedly iterates through the pairs of information items in the blacklist. During each iteration, each pair is selected at a second pair-selecting step 82. Following second pair-selecting step 82, the processor checks, at a second checking step 84, whether the last identified indication of unrelatedness for the pair is still recent. In other words, given (i) the current time t₁, and (ii) the time to of the last identified indication of unrelatedness that is specified in the blacklist, the processor checks whether t₁−t₀ is less than λ.

t₁−t₀ is less than λ, the processor returns to second pair-selecting step 82. Otherwise, the processor checks, at a third checking step 86, whether the data contain any recent indications of unrelatedness for the pair, i.e., any indications of unrelatedness exhibited after the time t₁−λ. If not, the processor removes the pair from the blacklist at a second pair-removing step 90. Otherwise, the processor updates the time of the last identified indication of unrelatedness for the pair at a time-updating step 88, and then returns to second pair-selecting step 82.

Typically, for efficiency, the processor performs third checking step 86 by passing through the data in reverse chronological order, from t₁ to t₁−λ. Upon identifying an indication of unrelatedness at t1−λ<t₂<t₁, the processor terminates third checking step 86, and then, at time-updating step 88, replaces the previous time associated with the pair with t₂.

It will be appreciated by persons skilled in the art that the present invention is not limited to what has been particularly shown and described hereinabove. Rather, the scope of embodiments of the present invention includes both combinations and subcombinations of the various features described hereinabove, as well as variations and modifications thereof that are not in the prior art, which would occur to persons skilled in the art upon reading the foregoing description. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. Apparatus, comprising:
a data-transfer interface; and
a processor, configured to:
receive data via the data-transfer interface,
based on the received data, identify (i) indications of relatedness, which indicate that respective pairs of information items are each related to one another, and (ii) indications of unrelatedness, each of which indicates that a respective pair of the pairs are unrelated to one another,
responsively to identifying the indications of relatedness and the indications of unrelatedness, maintain a repository in which a dynamic subset of the pairs are stored in association with respective relatedness scores, by continually modifying membership of the subset and the relatedness scores,
receive a query specifying a first one of the information items,
in response to the query, identify at least one second one of the information items that is paired with the first one of the information items in the repository, and
in response to identifying the second one of the information items, output the second one of the information items.

2. The apparatus according to claim 1, wherein the processor is configured to continually modify the membership of the subset by, in response to identifying any one of the indications of relatedness for a first one of the pairs that is not in the repository, and in response to a number of the pairs in the repository being equal to a predefined threshold, replacing a second one of the pairs, with which is associated, in the repository, a lowest one of the relatedness scores, with the first one of the pairs.

3. The apparatus according to claim 2, wherein the processor is configured to, in replacing the second one of the pairs with the first one of the pairs, set the relatedness score associated with the first one of the pairs higher than a second-lowest one of the relatedness scores.

4. The apparatus according to claim 2, wherein the processor is configured to continually modify the membership of the subset by, in response to identifying each indication of unrelatedness of at least some of the indications of unrelatedness, removing, from the repository, the pair for which the indication of unrelatedness was identified.

5. The apparatus according to claim 4, wherein the processor is further configured to add the removed pair to a blacklist, and wherein the processor is configured to replace the second one of the pairs with the first one of the pairs in response to the first one of the pairs not being in the blacklist.

6. The apparatus according to claim 5, wherein the processor is further configured to:
identify respective times at which, per the data, the indications of unrelatedness were exhibited, and
based on the identified times, remove, from the blacklist, any one of the pairs for which no indication of unrelatedness was exhibited for at least a predefined amount of time.

7. The apparatus according to claim 1, wherein the processor is configured to continually modify the relatedness scores by, in response to identifying any one of the indications of relatedness for any one of the pairs that is in the repository, increasing the relatedness score associated with the pair.

8. The apparatus according to claim 1, wherein the information items include a plurality of device-identifiers that identify respective devices.

9. The apparatus according to claim 8, wherein each of the pairs includes two of the device-identifiers.

10. The apparatus according to claim 8, wherein each of the device-identifiers is of a type selected from the group of types consisting of: an International Mobile Subscriber Identity (IMSI), an International Mobile Equipment Identity (IMEI), and a media access control (MAC) address.

11. The apparatus according to claim 8,
wherein the data include a plurality of images,
wherein the information items further include a plurality of features shown in the images, and
wherein each of the pairs includes a respective one of the device-identifiers and a respective one of the features.

12. The apparatus according to claim 11, wherein the features include respective faces.

13. The apparatus according to claim 8, wherein the information items further include respective event-types, and wherein each of the pairs includes a respective one of the device-identifiers and a respective one of the event-types.

14. The apparatus according to claim 1, wherein the processor is configured to identify the indications of relatedness by:
identifying respective times at which, per the data, the information items were exhibited, and
based on the identified times, identifying instances of coincidence, in each of which the respective times at which a respective one of the pairs were exhibited are separated by less than a predefined interval.

15. The apparatus according to claim 14,
wherein the predefined interval is a first predefined interval, and
wherein the processor is configured to identify the indications of unrelatedness by, based on the identified times, identifying instances of non-coincidence, in each of which the respective times at which a respective one of the pairs were exhibited are separated by more than a second predefined interval.

16. The apparatus according to claim 1, wherein the processor is configured to identify the indications of relatedness by:
identifying respective times and locations at which, per the data, the information items were exhibited, and
based on the identified times and locations, identifying instances of copresence, in each of which a respective one of the pairs were exhibited at respective ones of the times that are separated by less than a predefined interval, at respective ones of the locations that are separated by less than a predefined distance.

17. The apparatus according to claim 16,
wherein the predefined interval is a first predefined interval and the predefined distance is a first predefined distance, and
wherein the processor is configured to identify the indications of unrelatedness by, based on the identified times and locations, identifying instances of bilocation, in each of which a respective one of the pairs were exhibited at respective ones of the times that are separated by less than a second predefined interval but at respective ones of the locations that are separated by more than a second predefined distance.

18. The apparatus according to claim 1, wherein the processor is configured to identify the indications of relatedness on a first execution thread, and to identify the indications of unrelatedness on a second execution thread executed in parallel to the first execution thread.

19. A method, comprising:
receiving data;
based on the received data, identifying (i) indications of relatedness, which indicate that respective pairs of information items are each related to one another, and (ii) indications of unrelatedness, each of which indicates that a respective pair of the pairs are unrelated to one another;
responsively to identifying the indications of relatedness and the indications of unrelatedness, maintaining a repository in which a dynamic subset of the pairs are stored in association with respective relatedness scores, by continually modifying membership of the subset and the relatedness scores;
receiving a query specifying a first one of the information items;
in response to the query, identifying at least one second one of the information items that is paired with the first one of the information items in the repository; and
in response to identifying the second one of the information items, outputting the second one of the information items.

20. The method according to claim 19, wherein continually modifying the membership of the subset comprises, in response to identifying any one of the indications of relatedness for a first one of the pairs that is not in the repository, and in response to a number of the pairs in the repository being equal to a predefined threshold, replacing a second one of the pairs, with which is associated, in the repository, a lowest one of the relatedness scores, with the first one of the pairs. [symbol]
indication of unrelatedness was identified.

21. The method according to claim 19, wherein continually modifying the relatedness scores comprises, in response to identifying any one of the indications of relatedness for any one of the pairs that is in the repository, increasing the relatedness score associated with the pair.

22. The method according to claim 19, wherein the information items include a plurality of device-identifiers that identify respective devices.

23. The method according to claim 22, wherein each of the device-identifiers is of a type selected from the group of types consisting of: an International Mobile Subscriber Identity (IMSI), an International Mobile Equipment Identity (IMEI), and a media access control (MAC) address.

24. The method according to claim 19,
wherein the data include a plurality of images,
wherein the information items further include a plurality of features shown in the images, and
wherein each of the pairs includes a respective one of the device-identifiers and a respective one of the features.
